(19) United States
(12) Patent Application Publication
(10) Pub. No.: US 2007/0083288 A1
(43) Pub. Date: Apr. 12, 2007

(54) Minibar

(75) Inventor: Styrk Opheim, Bones (NO)

Correspondence Address: TOBIN, CARBERRY, O'MALLEY, RILEY, SELINGER, P.C., 43 BROAD STREET, PO BOX 58, NEW LONDON, CT, 06320, US

(73) Assignee: Oppie Design AS, BONES (NO)

(21) Appl. No.: 10/569,518

(22) PCT Filed: May 2, 2005
(86) PCT No.: PCT/NO05/00143

§ 371 Date: Feb. 23, 2006

(30) Foreign Application Priority Data
May 2, 2005 (WO) PCT/NO05/00143

(51) Int. Cl. G06F 17/00

(52) U.S. Cl. 700/237

(57) ABSTRACT

A device for a mini bar is described that can be operated by a customer to remove goods with the removal being registered by the mini bar operator simultaneously, and possibly invoiced, and is characterized in that the mini bar is a product unit vending machine, that the product unit vending machine comprises a control system with which restrictions for delivery of product units from the vending machine can be regulated.

### PRIORITY CLAIM

This Application claims priority to International Patent Application No. PCT/NO 2005/000143, filed on May 2, 2005.

### BACKGROUND

The present invention relates to a device for operation and control of the use of a mini bar in establishments such as overnight-stop companies and the like.

The invention also relates to a number of applications of the device according to the invention.

In addition to use in connection with ordinary mini bars in hotel rooms, the invention can be used in connection with lobbies, reception areas and other of the common rooms in the hotel and other facilities. It can also be used in connection with public areas, such as travel terminals, and in companies, schools and other relevant areas.

The mini bars that are in use today have, as a rule, the shape of a cupboard with a door. By opening the door, the customer has access to the whole of its content. There are also mini bars where the door can be opened with a dedicated mini bar key.

Product units from vending machines in public spaces can only be taken out on immediate payment by insertion of coins or payment via a card such as a credit card, cash card, mobile telephone or the like.

As a rule, a mini bar in a hotel room contains different products which the hotel guest may use during his stay. Such product can be different types of liquid refreshments, such as water, mineral water, lemonade, wine, spirits, and food products such as peanuts, salted cocktail sticks, chocolate and also tobacco and cigarettes. But other types of products may be relevant, e.g., personal care products such as toilet articles, soap, toothpaste, shaving equipment.

Manually operated mini bars of the simple manual refrigerator type dominate the market.

It is also possible to equip such mini bars with refrigerator functions to provide cooling and frozen goods (e.g., ice cream), and/or that they comprise heating elements so that the customer can, for example, heat soups and the like.

Normally, invoicing of product consumption takes place in that the customer himself, when checking out, states what he has taken or that the room service personnel perform a stock taking.

In addition, there are also automated solutions to improve the control of the use of mini bars. One of these comprises that all product units inside the mini bar are placed on respective pressure sensitive pads with connection to the invoicing system. When a product is removed, and is not put back within a given time, a signal is sent out that a purchase has been made and this is invoiced. The disadvantage with such a system is that the customer can temporarily remove the content in favor of his own goods and an erroneous invoicing takes place. It has been shown that such solutions do not give the expected reduction in loss either.

Another essential disadvantage with today's systems is that there is no possibility to control removal of the products that are subjected to regulations from the authorities, for example, alcohol and tobacco products to children and youths. Furthermore, the authorities have put time restrictions on the sale of alcohol.

None of this is today implemented as restrictions in mini bars in hotel rooms or in vending machines in open public areas.

New solutions that lead to a simplification and increased safety for the operation of vending machines can have a large market potential.

It is an aim of the present invention to provide a solution for a mini bar that will completely eliminate the disadvantages described above.

### SUMMARY

The following presents a simplified summary of the present invention in order to provide a basic understanding of some aspects of the present invention. This summary is not an extensive overview of the present invention.

It is an aim of the invention to be able to close down the free access to a mini bar so that the customer can no longer have free access to the whole of its content at the same time.

Furthermore, it is an aim of the invention to be able to control the delivery of goods in a vending machine/mini bar that stands in a common area, particularly with regard to its delivery of alcohol and other goods, the sale of which authorities have placed restrictions on.

It is also an aim to be able to remove all possibilities for loss from such mini bars by providing a solution that makes it impossible to take out goods from the mini bar without a safe payment or invoicing being performed.

At the same time, it is an aim of the invention that the front face of the vending machine shall provide a favorable impression of the content by showing the products on the front face of a mini bar shaped like a shop window for the products.

One of the features that satisfy these aims is that the classic mini bar is replaced by a vending machine where identification, payment or invoicing is completely necessary to be able to take a product from the vending machine.

The device according to the invention is characterized in:

that the mini bar is a product unit vending machine; and

that the product unit vending machine comprises a control system whereby conditions for delivery of the product units from the vending machine can be regulated.

According to the invention, the above mentioned device is used to have control over the stock in each individual vending machine, and also to produce an overview of the turnover from the mini bars.

Furthermore, the system is applied in connection with use in one of the facilities of a hotel, such as well-being departments, spa and massage parlors, swimming pools, fitness rooms, squash and tennis courts, discos, restaurants, Internet cafés, cinemas, etc., in that these comprise corresponding card readers that can be used in a mini bar and lobby bar, respectively.

One of the possibilities that the invention provides is that the system around a mini bar can be involved in the other information systems of a hotel where the TV set, with the remote control, is an important element. Thus, it is possible to invite the customer to purchase interactive services, and also display the selection possibilities the customer has, and also other information that the hotel wishes to present.

The system can consequently be used for:
a) selection of TV channels, and films for displaying on the TV screen 22 or the display 28;
b) displaying advertisements and other film material in connection with the goods which the customer orders, as described above; and
c) allowing the customer to get involved in, for example, marketing questionnaires and also games etc., as it is all controlled from the reception.

### BRIEF DESCRIPTION OF THE FIGURES

Referring now to the figures, wherein like elements are numbered alike:

FIG. 1 shows a section of a hotel room and shows a mini bar with an associated keyboard unit, display and connected TV set; and

FIG. 2 shows a flow diagram that shows how the different elements of the device are connected together.

### DETAILED DESCRIPTION

Persons of ordinary skill in the art will realize that the following disclosure is illustrative only and not in any way limiting. Other embodiments of the invention will readily suggest themselves to such skilled persons having the benefit of this disclosure.

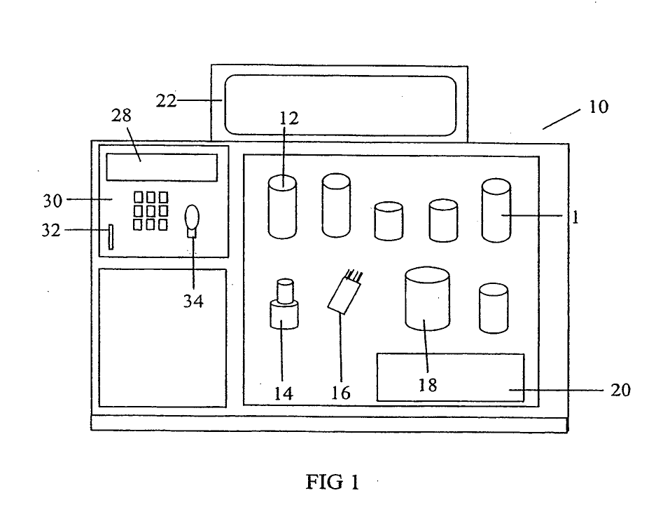

Initially, reference is made to FIG. 1 that shows an example of the front face of a mini bar that can be applied by the device according to the invention.

A Mini Bar

The mini bar 10, as a vending machine, can deliver a selection of product units to a delivery chute 20 that is inserted into the front side of the mini bar. In the front side, there is also an exhibition display for the displaying of the various goods, for example, boxes 12, bottles 14, chocolate 16 and boxes of candy 28. The purchased product units that are released into the chute 20 can correspond to the sizes that are shown in the display, but can also be different.

A display 28 and a keyboard 30 are shown to the left. The display 28 can have the shape and size of a TV screen, for example, to display service and selection information, advertisements and to offer interactive services to the customer. In some cases, the display can replace an ordinary TV set.

The products are chosen by using the keyboard, or by the use of buttons that are placed at or below each display.

The product units are placed in connection to a store and are delivered into the delivery chute 20 according to the customer's selection with the help of an internal mechanism in the mini bar, not shown in more detail.

A Lobby Bar

A lobby bar that is placed in the common areas is technically regarded as a mini bar. In addition, it is equipped as a standard vending machine that can be operated by coin insertion, or by the use of a credit card/mobile telephone. The data processor of the lobby bar is further set up to register the authorization of a user via his room key to take out products from the lobby bar that is subjected to restrictions.

Connection

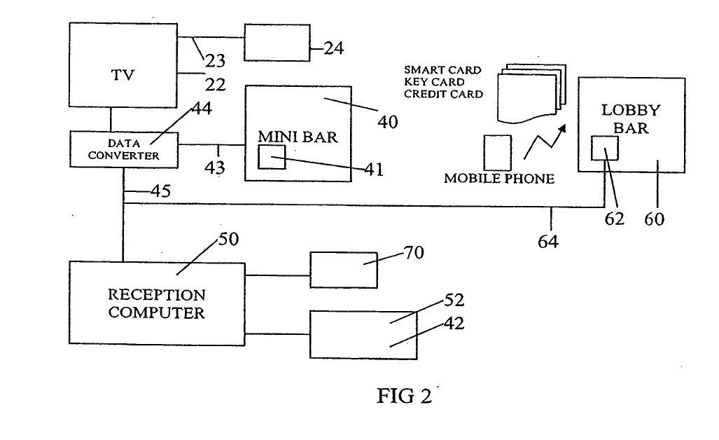

The mini bar/lobby bar is part of a system that can be seen in the flow diagram in FIG. 2.

How the mini bar 10 according to FIG. 1 is connected to the control system according to the invention is shown in FIG. 2.

The mini bar 10 according to FIG. 1 comprises its own data processor 41 which, via cable 43, is connected to a data converter 44 (that distributes data signals). The TV set 22 is also connected to this data converter 43 which in turn, via cable 45, is connected to a computer unit (CU) or data unit 40. The TV set 22 is wirelessly connected further to the remote control 24, symbolized by the connection 23.

The data unit 40 is connected to the keyboard/screen 47 to be programmed by an operator that can be the staff in the reception of the hotel where guests check in and out.

In addition, the data unit is connected to the data processor 62 of the lobby bar 60 via cable 64 and the lobby bar is controlled in the same way as the mini bar.

The individual units in this system can be connected together in a combination of cables and/or wireless. For example, cables can be laid in the ceiling construction of each floor and, at suitable locations, can be connected to transmitters/receivers for wireless transmission of signals between the data processor of the mini bar/lobby bar and the cable system.

Communication between data units and mini bar and lobby bar is a two-way operation.

All use by the customers of the mini bar 10 must be via the data unit 40, and this use by the customer is dependent on the restrictions and possibilities for purchase that are laid in (programmed in) the data unit 40 from the reception 50 (the control central). This means that nothing can be taken out from the mini bar without the reception having given a go-ahead signal via the data unit 40. That means everything can be delivered except those products that are subjected to blocking.

Invoicing

An essential feature of the invention is that, with all removal of products from the mini bar, either the bill that is presented to the guest is immediately invoiced, or a prepaid amount is already paid to take out goods. The system described above is also used in this payment function for the removing of all products.

A Hotel Room—the Guest's Own “Home”

The starting point for the invention is that when the guest has checked-in and closed the door to his room behind him, it is regarded as his own home. Then he shall have free access to all the products that are in the mini bar which in turn ensures that any removal of goods is automatically invoiced.

The access to the mini bar is consequently dependent on the customer having received an authorized access via a room key to the hotel room when checking-in at the reception. As the invoicing takes place automatically and immediately, nobody asks about who has removed the goods or what time of the day it took place.

Consequently, the keyboard that is in the front of the mini bar can be limited to constitute a selection button underneath each product unit that is on offer from the bar.

There is also the possibility that the mini bar is operating by cash payment, or by use of credit card for the removal of ordinary products such as drinks, food, chocolate, etc., without invoicing taking place. The company can still keep control of the consumption and get a central overview of status and when the stock of the mini bar must be replenished again.

Limitations on Removals from the Mini Bar

Previously, the restrictions from the authorities or, a wish for limitations on the serving of alcohol and tobacco, have not been possible to carry out in connection with mini bars in hotel rooms.

However, with the help of the new system according to the invention, the reception can now insert any restriction on the delivery of alcohol and tobacco products from the mini bar (i.e., both in relation to the age of the hotel guest (children/youths) and time of the day).

For example, when a group of youths check into a hotel, and get room keys, the receptionist types in the necessary data to the mini bar data processor 41 for the actual hotel rooms at the same time, so that no alcohol and tobacco products can be removed.

In addition to the above mentioned main component of the system, there are a number of elements with which the customer can take out products from the mini bar.

Use of “Member Card” and Credit Cards.

The customer can use a so-called member card which comprises a magnetic card or card with a chip that can be read. When used, a correct amount is subtracted directly from the customer's account, something that depends on the amount available to the card. These cards, smart cards, key cards and credit cards, are shown in FIG. 2 together with the option of using the mobile phone, see below.

Remote Control.

The remote control unit 24 can also be used to carry out the ordering via the TV set 22. At checking-in, the reception has already ensured that any order from the mini bar is invoiced to the customer via the data unit 50.

Mobile Telephone.

Any data unit 40 can also communicate with a mobile network, such as GSM or similar mobile networks. Thereby, the customer can, by hitting the correct keys on the mobile phone 60, also be able to open for ordering from the mini bar.

Independent of this, the reception can put in the necessary removal blockages (alcohol etc.) in the data processor of the mini bar.

Lobby Bar

With the present invention the system in a mini bar of a hotel can be moved out into the common areas of the hotel.

While a lobby bar can not offer the guest alcoholic beverages today, then the present invention opens up for this possibility. At the same time a full safeguard can be maintained against, for example, youths getting access to alcohol and furthermore, local restrictions for serving alcohol can be taken account for. There are also restrictions on sale of such goods in connection with public holidays, elections and the like.

On one hand, the vending machine functions as a typical vending machine, with the use of coins, credit cards and the like, or mobile phone.

On the other hand, the alcohol section of the lobby bar is limited to the hotel guests. To remove such goods, the guest must identify himself with the help of his room key that is inserted into the card reader. When this is checked by the data system, the customer can freely remove alcoholic beverages. The removal will be invoiced simultaneously.

When bars and restaurants in the hotel close their sale of alcohol for the night, a corresponding blockage can be put into the lobby bar.

Restriction Put into the Room Key

However, a lobby bar can not know if a guest that wants to use the lobby bar is old enough for alcoholic beverages and the like.

Therefore, the system according to the invention also comprises an option that the reception inputs restrictions in the magnetic strip or data chip of the room key itself. This insertion of restrictions in a room card 70 is shown schematically in FIG. 2.

This means that youth restrictions for access to the room mini bar, inserted into the data processor of the mini bar is correspondingly inserted into the room key for using the lobby bar.

Further Possibilities for Use of the System According to the Invention.

The new system according to the invention, where invoicing takes place automatically with the use of a room key, can also be used when the guest shall use the other facilities of the hotel, such as the well-being departments, spa and massage parlors, swimming pool, fitness rooms, squash and tennis courts, discos, restaurants, internet café, cinemas, etc., in that these comprise card readers corresponding to those used in the lobby bar.

For example, the reception can give all members of a family, adults and children, their own admission card to use such offers, and where each use is automatically invoiced. At the same time, the card used by a child gives free access to the facilities, which have been inserted by the reception staff, such as the swimming pool, the cinema, the disco and the playroom, but no possibility to take out alcohol from the lobby bar.

Interactive Services.

As mentioned, the display on a mini bar and a lobby bar can have the same form as the TV screen that is in the hotel room.

The mini bar and lobby bar can be part of a larger system connected to the reception, the TV system of the hotel. In this way, the system can be used for displaying, for example, advertisements, or other information on the display, or possibly also on the ordinary TV screen in the room. When the customer, for example, selects a can of coke via the keyboard unit or the remote control unit, the computer unit can put in an advertisement for the brand of coke on the display of the TV screen.

It is also possible to let the system offer the guest interactive services.

With the present invention, use of mini bars and lobby bars, can be much simplified, both for the hotel owner and the guest/user. Furthermore, one can satisfy the authorities' requirement of control with delivery of alcohol and the like from the vending machine, and a more secure invoicing than what has been possible previously.

The present invention will therefore lead to the previous problems of loss from mini bars being completely or partially eliminated.

The system can also be used so that the stock of each vending machine can be controlled, and consequently which mini bars goods must be restocked. Furthermore, it is easy to obtain statistical information about the turnover from the mini bar.

It is possible to provide all this without anybody having to manually count how much is left in the mini bar when the guest has gone, as was the case previously.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiment disclosed as the best mode contemplated for carrying out this invention.

What is claimed is:

1. A system for delivery of product units from a vending machine to a customer, comprising:
a control central; and
a closed vending machine comprising a control unit configured to control conditions for delivery of the product units from the closed vending machine and configured to register information about product content in the closed vending machine, wherein the control central is configured to continuously collect information about the product content from the control unit and is configured to control the conditions of delivery in the closed vending machine for each customer, wherein the conditions of delivery are sent to the control unit.

2. A system according to claim 1, wherein the control central is configured to continuously register the products units that are delivered to the customer, and wherein product unit that the customer buys is debited by the control center automatically after the purchase.

3. A system according to claim 1, wherein the control unit is programmed via the control central to regulate which of the products units can be delivered from the vending machine and which of the products units are blocked from delivery.

4. A system as in any of the preceding claims, wherein the control central comprises arrangements to rebate the customer for some or all products in the closed vending machine.

5. A system according to claim 1, wherein the closed vending machine is configured to be operated by a feed-unit, wherein said feed-unit is selected from a group comprising a keyboard, a remote control unit and other wireless unit.

6. A system according to claim 1, wherein a TV set is connected to the control central, and the vending machine is arranged to be operated via the remote control of the TV set.

7. A system according to claim 1, wherein access to the vending machine is conditioned by the use of a correct room key, wherein the access to the room gives a corresponding access to the closed vending machine against a simultaneous invoicing of all withdrawals.

8. A system according to claim 5, further comprising:
a card reader coupled to the vending machine, wherein said card reader reads at least one of a magnetic card of and another storing body and is used in combination with a code that can be keyed into the feed unit to activate the closed vending machine.

9. A system according to claim 1, wherein said conditions of delivery comprise delivery of products units which are subjected to restrictions of at least one of age limits and time related restrictions.

10. A system according to claim 9, further comprising:
a display coupled to the closed vending machine and configured to show selection possibilities and to present information.

11. A system according to claim 1, wherein the closed vending machine is located in a hotel room, and the control central is operated from the hotel reception by an operator.

12. A system for delivery of product units from a lobby vending machine to a plurality of customers, comprising:
a control central; and
a closed vending machine, placed in a common area, comprising a control unit configured to control conditions for delivery of the product units from the vending machine, and configured to register information about the product content in the closed vending machine, wherein the control central controls the conditions for delivery in relation to which product units can be delivered from the vending machine to the customer, and which product units are prevented from being delivered.

13. System according to claim 12, wherein the closed vendor machine is located in a hotel's facilities selected from the group consisting of lobbies, well-being departments, spa and massage parlors, swimming pools, fitness rooms, squash and tennis courts, discos, restaurants, internet cafes, and cinemas.

14. Method for delivery of product units from a vending machine to a customer, comprising:
a control central; and
a vending machine comprising a control unit that controls conditions for delivery of the product units from the vending machine and registers information about product stock in the vending machine, wherein the control central continuously collects information about product stock from the control unit and wherein the conditions for delivery in the vending machine are controlled by an operator that inserts conditions for a customer that are sent to the control unit.

15. Method according to claim 14, wherein the control central registers the products units that are delivered to the customer continuously, and debits the customer automatically, after the purchase of the product unit.

16. Method according to claims 14 or 15, wherein the vending machine releases the product unit from the vending machine stock and delivers the chosen product unit to the customer via a delivery chute if the control of the control unit cancels the blocking function.

17. System according to claim 12, wherein the closed vending machine is located in public areas selected from the group consisting of travel terminals, companies, and schools.

18. System according to claim 12, further comprising:
a corresponding card reader coupled to the vending machine, wherein said card reader reads at least one of a magnetic card and another storing body and is used in combination with a code that can be keyed into the feed unit to activate said closed vending machine.
